(19) United States
(12) Patent Application Publication
(10) Pub. No.: US 2025/0292005 A1
(43) Pub. Date: Sep. 18, 2025

(54) Intelligent Data Annotation System

(71) Applicant: Measurement Incorporated, Durham, NC (US)

(72) Inventors: Corey J. Palermo, Durham, NC (US); Ariantio Wibowo, Raleigh, NC (US)

(73) Assignee: Measurement Incorporated, Durham, NC (US)

(21) Appl. No.: 19/079,972

(22) Filed: Mar. 14, 2025

Related U.S. Application Data
(60) Provisional application No. 63/565,238, filed on Mar. 14, 2024.

(51) Int. Cl. G06F 40/169

(52) U.S. Cl. CPC G06F 40/169

(57) ABSTRACT

Disclosed is a computer-implemented method and system for intelligently classifying and annotating data across various annotation tasks, including labeling, tagging, scoring, and metadata assignment. The system measures human annotator consistency using carefully selected, pre-annotated benchmark tasks that serve as stable standards for evaluating annotators. It dynamically identifies annotators demonstrating the highest consistency and utilizes their annotation data to train a machine annotation model. Confidence values, reflecting the estimated accuracy of machine-assigned annotations, are calculated to guide the intelligent routing of annotation tasks. Tasks with high confidence are annotated by the machine model, whereas tasks below the confidence threshold are strategically routed to the highest-performing human annotators. This method and system enhance annotation accuracy, reduces annotator drift, and significantly lowers overall annotation costs across diverse labeling, tagging, scoring, classification, and related annotation activities.

### CROSS REFERENCE TO RELATED APPLICATIONS

This application claims the benefit of U.S. Provisional Patent Application Ser. No. 63/565,238, filed Mar. 14, 2024, which is incorporated by reference herein in its entirety.

### BACKGROUND OF THE INVENTION

### Field of the Invention

The present invention relates generally to machine learning and data processing, with a focus on data labeling, classification, and annotation tasks. Specifically, this invention presents a system for intelligently routing annotation tasks for either human or machine-based annotation.

### Description of the Related Art

Conventional annotation systems, which rely on the manual or semi-automated process of adding metadata, labels, or tags to data points face several challenges. One set of problems relates to subjectivity and variability of human data annotators. Human annotators may interpret annotation criteria or guidelines differently, causing inconsistencies and reducing the reliability of annotated data. A related problem impacting high-volume annotation projects is annotator inconsistency over time, requiring continuous monitoring and retraining to maintain quality. Human annotators' experiences, cultural background, or implicit assumptions can introduce biases, impacting the fairness and generalizability of machine learning models. An additional problem is limited expertise. Specifically, annotators' lack of domain-specific knowledge can result in errors or poor-quality annotations, particularly in specialized fields.

Conventional annotation approaches also face problems associated with the annotation tasks themselves. A key challenge is ambiguity and complexity. Some annotation tasks, especially those involving subjective judgment or complex semantics, can be inherently ambiguous, requiring additional time and effort to resolve. Furthermore, conventional annotation systems often lack real-time feedback mechanisms, making it difficult to promptly address errors during the annotation process.

Scalability, the property of a system to manage a growing amount of work, is a problem with conventional annotation approaches. Manual annotation is often time-consuming and labor-intensive, creating bottlenecks for large datasets.

An additional problem is high costs. Reliance on human labor makes annotation expensive, which may not be feasible for projects with tight budgets.

While the conventional annotation approaches may be suitable for straightforward annotation tasks involving objective data and non-critical applications, they are not as suitable for complex, subjective, and large annotation tasks. Conventional annotation approaches do not maximize the consistency of the annotations. Conventional annotation approaches are time-consuming and expensive. The proposed intelligent annotation system substantially departs from the conventional systems and methods of the prior art, and in so doing provides a system for annotating data developed for the purpose of improving annotation consistency and lowering the overall cost of data annotation.

### SUMMARY

This invention addresses the limitations and challenges inherent current annotation systems now present in prior art. In one embodiment, the annotation system utilizes intelligent annotation methods designed to enhance annotation consistency while reducing the overall cost of data annotation. The primary purpose of this invention is to introduce an innovative annotation system for data requiring labels, tags, scores, or metadata. This system not only retains benefits of conventional annotation systems but also incorporates novel features and functions. These advantages result in a unique system that is neither anticipated, rendered obvious, suggested, nor implied by any prior art, whether considered individually or in combination.

In accordance with one embodiment, a combination of human and machine annotators is employed. The process generally involves actively measuring the quality of human annotator consistency through benchmark tasks, identifying the most consistent human annotators at any given time, and determining an optimal goodness-of-fit threshold. This threshold enhances agreement between human-or machine-generated annotations and a set of benchmark annotations during model training. Data annotation tasks are then classified based on their alignment with benchmark annotations. The least aligned—and thus most challenging—tasks are intelligently routed to the most accurate human annotators, while tasks closely aligned with benchmark annotations are automatically assigned.

The system's processes utilize a confidence value threshold designed to optimize agreement between human—or machine—assigned annotations to a set of pre-annotated benchmark tasks exclusively. Additional system functions include computing confidence values which measure the extent to which the machine algorithm is expected to accurately assign each annotation, identifying a confidence value threshold for classifying annotation task data, applying the machine annotations to those tasks that are more likely to be correctly annotated using the machine annotations model (i.e., high confidence annotation tasks); classifying machine annotations based on whether each exceeds the confidence value threshold, intelligently routing those annotation tasks to the most accurate human annotators at the time, and automatically collect annotations on benchmark tasks.

Objects of the present invention are to provide an annotation system for data requiring labels, tags, scores, and/or metadata annotation that will overcome the shortcomings of the prior art systems, and to provide an annotation system configured to improve the consistency and validity of annotations above confidence value thresholds by humans and machines.

Additional objectives of this invention are to:
(i) provide an annotation system that reduces the time required to annotate data.
(ii) provide an annotation system that reduces the total annotation cost; and
(iii) provide an annotation system that optimally utilizes machine capabilities and human expertise.

Another aspect of the system is to minimize the need for extensive human intervention in annotation tasks by increasing the proportion of machine-assigned annotations while decreasing the proportion of human-assigned annotations.

Another object is to provide an annotation system that measures human annotation quality directly via benchmark annotation tasks, preventing annotator drifting and providing a reliable benchmark for label consistency.

Another object is to provide an annotation system in which machine-assigned classifications replicate expert human annotations.

Other advantages of one or more aspects will be apparent from consideration of the drawings and ensuing written description.

### BRIEF DESCRIPTION OF DRAWINGS

In the drawings, when appropriate, closely related figures have the same number but different alphabetic suffixes.

FIG. 1 is a schematic diagram of a system for classifying and annotating annotation tasks involving both human and machine annotations according to one embodiment.

FIG. 2 is a schematic diagram of details of the system for evaluating human annotator consistency.

FIG. 3 is a schematic diagram of the process of creating a machine annotation model for annotation tasks.

FIG. 4 is an illustrative example depicting the Typical Gain in Human-Machine Agreement by Increasing Confidence Threshold Values according to one embodiment of the invention.

### DETAILED DESCRIPTION

The data annotation system for intelligently routing annotation tasks collects annotation task data and utilizes technological methods to measure human annotator consistency by applying predetermined methods. The system functions to identify the most accurate human annotators from a pool at any given time. The system has an ongoing process of training and retraining via the machine learning algorithm using annotation task data from the most accurate human annotators. The system utilizes confidence values, which measure the extent to which the machine learning algorithm is expected to assign each annotation accurately. Essential system methods include classifying annotation task data based on said confidence values and intelligently routing the annotation tasks least likely to be currently annotated by the machine algorithm, as indicated by low confidence values, to the most accurate human annotators at any given time for human annotation and assigning machine annotations to those annotation tasks that are more likely to be correctly annotated by the machine learning algorithm.

An automated computer processor automatically selects skilled annotators'assigned scores via a data-driven labeling engine, an algorithm for evaluating the degree of alignment between human and machine annotations to determine an algorithm best for predicting expert-assigned scores, an optimal measure of agreement between human and machine-assigned annotations, such as the quadratic-weighted kappa metric, an algorithm to select a confidence threshold based on the relationship between the confidence threshold and the measure of agreement. The data-driven labeling engine is uniquely configured to cooperate with the automated computer processor to maximize annotation consistency and select a confidence threshold value that optimizes the measure of agreement.

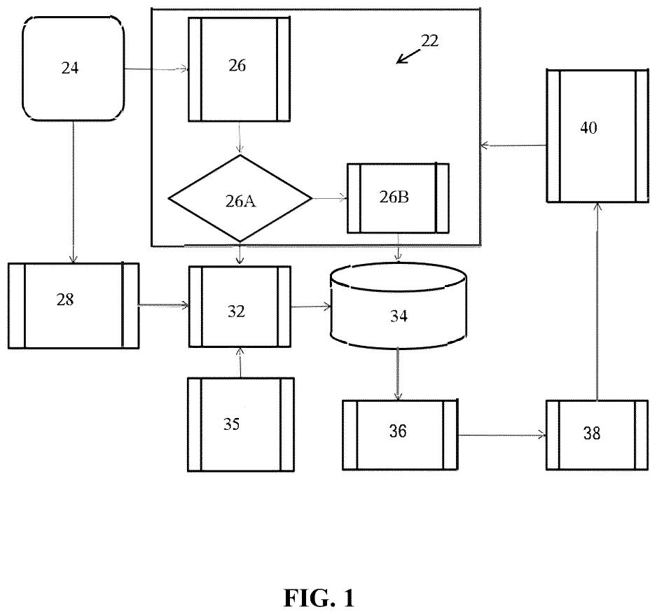

One embodiment of the data annotation system is illustrated in FIG. 1 which shows a system for Classifying and Routing (CR) 22 Tasks Requiring Annotation (TRA) 24 resulting in a combination of human-and machine Final Annotation (FA) 34, configured to improve consistency of annotations while lowering overall cost of data annotation.

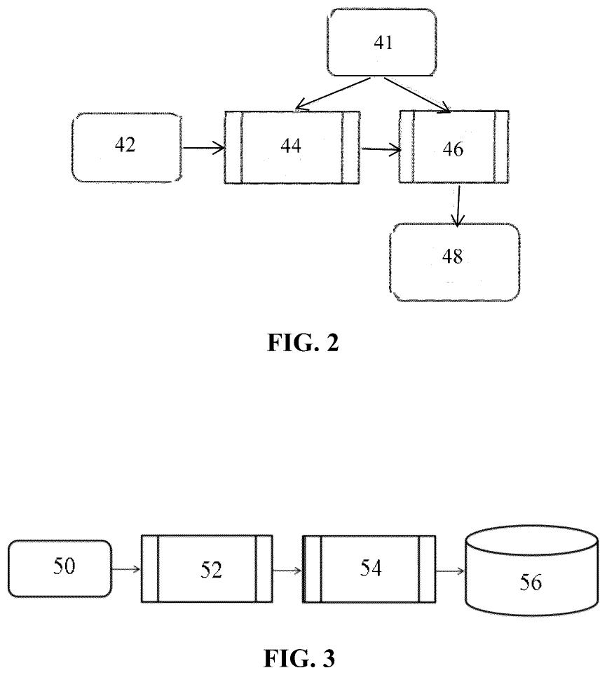

Still referring to FIG. 1, the schematic diagram indicates that the procedure to Apply Machine Annotation (AMA) 26B involves Create Machine Annotation (CMA) 26 and determining whether the machine annotation is Above Confidence Value Threshold (ACVT) 26A. If the machine annotation is determined to be above the confidence threshold in ACVT 26A, then the machine annotation is applied as shown in AMA 26B. On the other hand, if the machine annotation is not above the confidence value threshold determined in ACVT 26A, the task is routed to the most consistent human annotators, to Collect Annotations from Most Consistent Human Annotators (CA FMCHM) 32. The CA FMCHM process is informed by the results of the Human Annotator Evaluation (HAE) 35 and described in FIG. 2. Final Annotation 34 combines outputs of both machine annotation 26B and human annotations CA FMCHM 32.

FIG. 1 further illustrates the process for training a machine annotation model and identifying a confidence value threshold. In this case, TRA 24 are subject to a Random Sampling of Training Annotation Model process (RSTAM) 28. The randomly sampled tasks are routed to CA FMCHM 32, producing high-quality training data used to Train Machine Annotation Model (TMAM) 36. TMAM 36 is illustrated in FIG. 3 which describes an embodiment of the process of training an annotation model. The output of TMAM 36 is used to Identify Confidence Value Threshold (ICVT) 38, essential to the system's objective to attain maximum consistency.

Still referring to FIG. 1, the schematic diagram shows ICVT 38 functions to input to the Update Machine Annotator Model and Confidence Value Threshold (UMAMC & CT) 40 module. UMAMC & CT is configured to output into system CR 22.

FIG. 2 illustrates an embodiment of a system for evaluating Human Annotator 42 consistency. It is noted that for purposes of this invention terms “raters” and “annotators” can be used interchangeably. Raters synonyms include observers, analysts, commentators, reviewers, columnists, critics, judges, appraisers, referees, and evaluators. In context, raters are individuals who assess or evaluate something based on predefined criteria. Raters might score, rank, or provide feedback on myriad items, such as product quality, performance, or user-generated content.

Annotators' synonyms include analysts, columnists, commentators, observers, critics, pundits, reviewers, appraisers, evaluators, and judges. In context, annotators add explanatory notes or comments to a text, image, or other content. Annotators highlight vital details, provide context, or offer insights. Annotators are commonly associated with tasks involving reviewing data and assigning relevant labels or tags based on predefined criteria or guidelines. It is appropriate in certain contexts for the terms “raters” and “annotators” to be used interchangeably, especially when the goal is to describe individuals who evaluate or provide additional information about something. Accordingly, in this embodiment, and other embodiments, the terms raters and annotators are used interchangeably.

Still referring to FIG. 2, the schematic diagram shows a method and system for evaluating human annotator consistency. This starts with collecting Pre-Annotated Benchmark Tasks (PABT) 41. PABT 41 are assigned to Human Annotators (HA) 42 in order to Collect Annotation on Benchmark Tasks (CABT) 44. These annotations are compared to the gold-standard annotations associated with the benchmark tasks. The process of Evaluate Annotation Consistency (EAC) 46 provides a Measure of Human Annotator Consistency (MHAC) 48. Benchmark tasks used for consistency evaluation are carefully selected and periodically updated. Specifically, benchmark annotations are derived from expert annotators who consistently meet predefined high-quality criteria, such as high Quadratic Weighted Kappa (QWK) or inter-annotator agreement metrics. This curated benchmark set provides an objective standard for continuous monitoring of annotator accuracy, ensures stable reference points for measuring consistency, and mitigates annotator drift over time.

FIG. 3 shows an embodiment of the process for training a machine annotation model. First, features are extracted from Pre-Annotated Tasks (PAT) 50 via Extract Task Features (ETF) 52. Next, using pre-annotations and extracted features, machine learning is used to Find Relationship Between Task Features and Task Annotations (FRBTF) 54. This results in a Machine Annotation Model (MAM) 56.

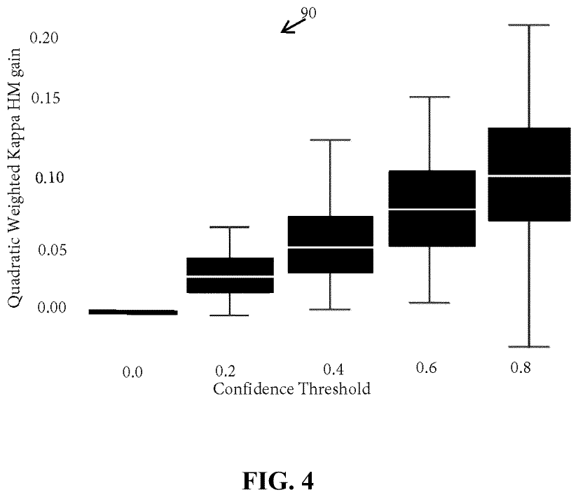

FIG. 4 shows the typical gain in human-machine agreement by increasing confidence threshold from an embodiment of the system for classifying and annotating annotation tasks involving both human-and machine annotations (FIG. 1), focusing on annotation tasks involving scoring or rating annotations. Although FIG. 4 specifically uses Quadratic Weighted Kappa (QWK) as an agreement metric for clarity, the concept of increasing confidence thresholds to improve human-machine annotation agreement generalizes broadly beyond scoring tasks to include various forms of data labeling, tagging, classification, and other annotation types encompassed by this invention. FIG. 4 shows a positive relationship between increasing Confidence Threshold values (shown on the X-Axis), and positive gains in the Human-Machine (HM) Quadratic Weighted Kappa Human-Machine (HM) gain values on the Y-Axis. Graph 90 is used to illustrate typical gain in Human-Machine agreement attained by increasing Confidence Threshold values.

Table 1 provides a comparative analysis of the conventionally used Fixed-Cutoff Approach with the floating-type Confidence Threshold Approach used in the present invention, using QWK as an example measure of inter-annotator agreement.

TABLE 1

| | | | Fixed 15% | Floating QWK |
|---|---|---|---|---|
| | Human | Model | Approach | Approach (Cutoff |
| Annotation | Consensus | Confidence | (Cutoff at 15th | Adjusts to Meet |
| Task | (%) | (%) | Percentile) | Target QWK) |
| Task A | 85% | 95% | [symbol] Machine | [symbol] Machine annotates |
| | | | annotates | (High QWK) |
| Task B | 80% | 92% | [symbol] Human | [symbol] Machine annotates |
| | | | annotates | (Meets QWK target) |
| | | | (Outside 15%) | |
| Task C | 65% | 78% | [symbol] Human | [symbol] Human annotates |
| | | | annotates | (Confidence too low) |
| | | | (Outside 15%) | |
| Task D | 70% | 80% | [symbol] Machine | [symbol] Human annotates |
| | | | annotates | (Below QWK threshold) |
| | | | (Within 15%) | |

The above analysis indicates that the Fixed-Cutoff Approach always assigns the lowest-confidence 15% of tasks to humans, even if they could be reliably handled by the machine. In comparison, the floating-type Confidence Threshold Approach of the present invention adjusts the cutoff dynamically, ensuring that the QWK agreement remains above a pre-specified target rather than relying on an arbitrary percentage.

The invention advantageously provides an intelligent annotation system and methods for annotating data that improve annotation consistency and lower the overall cost of data annotation. The invention described also improves the consistency and validity of annotations above confidence value thresholds by humans and machines. The invention described significantly reduces the time required to annotate data; reduces the total annotation cost; and optimally utilizes machine capabilities and human expertise.

Additionally, the present invention provides an annotation system that measures human annotation quality directly via benchmark annotation tasks, preventing annotator drifting and providing a reliable benchmark for label consistency.

The present invention may be embodied in other specific forms without departing from its scope or essential characteristics. The embodiments described are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method for training a machine annotation model, the method comprising:
a) receiving inputs from one or more human annotators on plurality of pre-annotated benchmark data;
b) comparing the received inputs from one or more human annotators with gold-standard annotations;
c) determining a consistency level of one or more human annotators based on the comparison to identify one or more subsets of human annotators having the highest consistency level;
d) clustering the annotated task data of the identified subset of human annotators into a weighted dataset to identify task features and task annotations; and
e) training a machine annotation model using the annotation task data obtained from the identified subset of human annotators to obtain a confidence value threshold.

2. The method of claim 1, wherein the gold-standard annotations over a predefined number of benchmark tasks are based on predefined criteria or guidelines; and wherein determining the consistency level of one or more human annotators is based on a pre-defined metric selected from a quadratic-weighted kappa metric.

3. The method of claim 1, wherein the machine annotation model is trained using a weighted dataset, wherein said dataset includes annotations data from one or more human annotators matching a pre-specified requirement.

4. The method of claim 1, wherein the confidence value threshold is dynamically updated based on periodic reassessment of the consistency levels by the machine annotation model to ensure that the Quadratic Weighted Kappa (QWK) of machine-annotated tasks meets a pre-specified target.

5. The method of claim 1, wherein the confidence value threshold is set at the level where the machine's annotations match human annotations with at least the desired QWK score.

6. The method of claim 1, further comprising re-training the machine annotation model after a pre-determined period with updated annotation task data and the consistency level obtained from the identified subset of human annotators.

7. A computer-implemented method for classifying and routing annotation tasks based on a pre-determined confidence threshold value, the method comprising:
(a) receiving, from users, one or more content data for annotation;
(b) identifying, by the machine annotation model, one or more features or patterns in the content data for annotation;
(c) generating and assigning, by the machine annotation model, annotation to the content data based on one or more identified features or patterns
(d) validating, by the machine annotation model, the machine generated annotated content data against a pre-determined confidence value threshold, wherein the confidence value threshold indicates a likelihood that the machine annotation model satisfies pre-specified requirement, and
(e) routing annotated data having a confidence value threshold below the pre-determined confidence value threshold to a subset of human annotators with a highest consistency level in annotated benchmark data test for manual annotation.

8. The method of claim 7, wherein the confidence values are computed based on a probabilistic model determined from a features or pattern identified by said subset of human annotators.

9. The method of claim 7, further comprising assigning weighted measurement to annotations based on the measured confidence value.

10. The method of claim 7, wherein the annotations having a lower weighted measurement is additionally reviewed by the subset of human annotators; and wherein the pre-determined confidence value threshold is dynamically adjusted based on real-time annotation accuracy metrics of the machine annotation model.

11. The method of claim 7, wherein the human annotator consistency is measured using an agreement metric selected from quadratic-weighted kappa, inter-annotator agreement score.

12. The method of claim 7, wherein annotation tasks routed to the identified subset of human annotators for manual annotation are reintroduced into the machine annotation model to improve future classification accuracy.

13. The method of claim 7, further comprising storing annotated data in a structured repository for retraining machine annotation model and updating the confidence threshold value.

14. A system for training a machine annotation model and classifying and routing annotation tasks, the system comprising
an automated computer processor configured to:
a) receive inputs from one or more human annotators on a plurality of pre-annotated benchmark data;
b) compare the received inputs from one or more human annotators with pre-annotated benchmark annotations;
c) determine a consistency level of one or more human annotators based on the comparison and identify one or more subsets of human annotators having the highest consistency level;
d) cluster the annotated task data of the identified subset of human annotators into a weighted dataset to identify task features and task annotations based;
e) train a machine annotation model using the annotation task data obtained from the identified subset of human annotators for identifying a confidence value threshold;
f) receive one or more content data to be annotated;
g) identify, using the trained machine annotation model, one or more features and patterns in the content data being to be annotated;
h) generate and assign annotations to the content data based on the identified patterns;
i) validate the machine generated annotated content data against a pre-determined confidence value threshold, wherein the confidence value threshold indicates a likelihood that the machine annotation model satisfies pre-specified requirement, and
j) assign annotation tasks that fall below the confidence threshold to the identified one or more subsets of human annotators for manual annotation.

15. The system of claim 14, wherein the benchmark task evaluation module assigns benchmark tasks to human annotators and evaluates their consistency using a pre-defined agreement metric, such as the quadratic-weighted kappa metric.

16. The system of claim 14, wherein the confidence value computation module determines confidence thresholds based on the relationship between confidence values and is based on predefined criteria or guidelines human and machine annotations.

17. The system of claim 14, wherein the task routing module assigns annotation tasks below the confidence value threshold to human annotators based on their measured consistency levels; and wherein the machine annotation model updates its training based on newly collected human-verified annotations to improve future predictions.

18. The system of claim 14, wherein the continuous learning module updates both the machine annotation model and confidence value threshold dynamically based on performance metrics.

19. The system of claim 14, wherein the machine annotation model is trained using a weighted dataset, where annotations from human annotators with higher consistency levels are assigned greater importance.

20. The system of claim 14, further comprising storing annotated data in a structured repository for future annotation model improvements and consistency audits.
